(19) United States
(12) Patent Application Publication
(10) Pub. No.: US 2015/0220928 A1
(43) Pub. Date: Aug. 6, 2015

(54) PLATFORM FOR THE PURCHASE AND SALE OF DIGITAL CURRENCY

(71) Applicant: Robert Allen, Palm Coast, FL (US)

(72) Inventor: Robert Allen, Palm Coast, FL (US)

(21) Appl. No.: 14/210,414

(22) Filed: Mar. 13, 2014

Related U.S. Application Data
(60) Provisional application No. 61/933,992, filed on Jan. 31, 2014.

(51) Int. Cl. G06Q 20/40; G06Q 20/38; G06Q 20/06

(52) U.S. Cl. CPC G06Q 20/4016; G06Q 20/0655; G06Q 20/3829

(57) ABSTRACT

A platform for buyers and sellers of digital currency is disclosed. The platform comprises different modules which can be used alone or in combination. When used together, they provide for a fully automated experience for a user, from account sign-up through to funds settlement. Using the platform, a buyer or seller can participate in virtually instantaneous transactions of digital currency. The platform can be expanded to buy and sell other commodities in addition to digital currency. The platform can permit users to fund or settle accounts using commodities such as gold rather than a globally traded currency.

### RELATED APPLICATION

This application is a non-provisional of U.S. Provisional Application No. 61/933,992 filed Jan. 31, 2014, the disclosure of which is incorporated herein in its entirety by reference.

### FIELD OF THE INVENTION

The invention relates to a platform for buyers and sellers of digital currency. The invention comprises different modules which provide for a fully automated experience for a user, from account sign-up through to fulfillment. Using the platform of the invention, a buyer or seller can participate in virtually instantaneous transactions of digital currency. The platform can be expanded to buy and sell other commodities in addition to digital currency.

### BACKGROUND OF THE INVENTION

Money acts as a medium of exchange that is generally accepted as payment for goods and services and repayment of debts. Any kind of object or secure verifiable record that fulfills these functions can be considered money. Commodity money derives its value out of the commodity out of which the good/money is made from, such as gold or silver. Nearly all contemporary money systems are based on fiat money that derives its value by being declared by a government to be legal tender.

Cryptocurrency is a digital medium of exchange. Numerous cryptocurrencies exist today such as Bitcoin, Ripple, Litecoin, Peercoin, Namecoin, Dogecoin, Primecoin and Mastercoin. Cryptocurrencies essentially are specifications regarding the use of currency that incorporate principles of cryptography. Compared to fiat money, no group or individual may accelerate, stunt or in any other way significantly abuse the production of cryptocurrency. Instead, only a certain amount of cryptocurrency is produced by the entire cryptocurrency system collectively, at a rate which is bounded by a value that has been prior defined and publicly known. Dozens of cryptocurrency specifications have been defined, and most are similar to and derived from the first fully implemented cryptocurrency protocol, bitcoin. Within cryptocurrency systems, the safety, integrity, and balance of all ledgers is ensured by a group of mutually distrustful parties, referred to as miners, who actively protect the network by maintaining a proof of work having a high hash-rate difficulty for a chance at receiving a randomly distributed small fee.

The following description will be made in terms of bitcoin, although the principles set forth apply for most part to any cryptocurrency although there may be differences now known or later developed between bitcoin and other cryptocurrencies.

Bitcoin is a digital currency introduced as open source software in 2009 that uses cryptography to control the creation and transfer of money. A bitcoin is defined by a chain of digitally signed transactions that began with its creation as a “block” reward. The Bitcoin network shares a public ledger called the “block chain” that contains a history of every confirmed bitcoin transaction ever processed, which allows a user's computer to verify the validity of a particular bitcoin transaction, i.e. that the bitcoins are actually owned by a particular person. The block chain records every single transaction—present and past—and the ownership of every single bitcoin in circulation. This public database of all bitcoin transactions is a guard to prevent double-spending of bitcoin.

Bitcoin works off the principles of public key cryptography. A bitcoin address is a randomly generated public key pair, a public key and a private key, which is generated and stored in a user's digital “wallet.” The wallet is a free, open-source software program that generates Bitcoin addresses, maintains a bitcoin balance and allows users to send or receive bitcoins, pay for goods or save money in the form of bitcoin. Users send payment in bitcoin to others by broadcasting transactions, or digitally signed messages, to the Bitcoin network, specifying the recipient's address and the amount of bitcoin to be transferred. The sender “signs” the transaction with his/her private key so that anyone with the sender's public key can verify that the transaction is in fact originating with that sender.

Each time a transaction is broadcast on the Bitcoin network, a “miner” processes the transaction to ensure that all the information in the transaction is correct and then updates the block chain. For a transaction to be confirmed, it must be included in a “block” along with a mathematical proof of work performed by the miner. Miners are awarded bitcoins as “block” rewards each time they create a new block that is added to the block chain. These proofs are very difficult to generate, and are designed to depend on the previous block, making it exponentially difficult to reverse previous transactions.

Validation (or confirmation) of a bitcoin transaction may require between 1 and 6 confirmations on the network, with each successive confirmation adding greater confidence that a transaction is valid. A confirmation means that there is a consensus on the network that the bitcoins involved in the transaction have not been sent to anyone else and are the property of the user. Once there is confirmation of the transaction, the amount of bitcoin is transferred to the recipient's wallet. Every user is free to determine at what point they consider a transaction confirmed, but 6 confirmations is often considered to be as safe as waiting 6 months on a credit card transaction. Usually after the first confirmation it is almost guaranteed that a transaction is valid. This confirmation process may take anywhere from a few minutes to 2 hours and varies according to network load and server availability.

Bitcoin and other digital currency are typically obtained by mining; accepting it as a payment for goods and services; or buying it from a friend or from an exchange. Bitcoin exchanges include BitBargain; Bitcoin-Central; bitcoin.de; Bitcoin-24; BitMarket.co; bitNZ; Bitstamp; BTC-E; CampBX.com; Intersango; Kapiton.se; MtGox; OTC Exchange; The Rock Currency Exchange; Real Bitcoin; Vircurex; VirtEx; VirWoX; WeExchange.co; and SnapSwap. Exchanges allow for users to enter buy orders and sell orders. A buy order is executed partially or in full when the price bid can be matched against a sell order that is at or below the bid amount. A sell order is executed partially or in full when the price asked can be matched against a buy order that is at or above the ask amount. Orders that cannot be matched immediately remain in the orderbook. For example, a registrant on MtGox has at least two sub-accounts: one for bitcoins and one for US dollars or other national currency. Bitcoins are bought using funds from the user's national currency account, and the proceeds from the sale of bitcoins are deposited into the same account. On MtGox, trading always involves bitcoins as trading between different national currencies is not offered. Trades on Mt. Gox's execute from balances on deposit with the exchange which in turn makes trading on the market instantaneous. In comparison, on other Bitcoin markets, subsequent settlement occurs manually between the trading partners. Exchanges make money by charging fees for each successful trade, typically as a % of the amount of the trade. Fees may be charged of both the buyer and the seller.

The process of purchasing and selling a digital currency such as bitcoin can be a frustrating and cumbersome process for the user. It takes a great deal of time for a user to set up a trading account in an exchange because physical documents are required to be submitted for manually review and checks. It also takes a long time to settle and receive funds when the user buys or sells bitcoin on the exchange. For example, most settlements are conducted by wire or paper checks and can take a great deal of time, sometimes up to several weeks, to conclude, so users do not have instant access to funding their accounts or settling their accounts with the exchange. This prevents buyers and sellers from having the ability to conduct a virtually instantaneous transaction and possibly lose out on opportunities that are no longer available once their accounts are funded. Otherwise, buyers would have to maintain money in their account which is not a good use of those funds.

At this time, no bitcoin exchanges allow for funding of a user account using a credit or debit card, most likely due to the high fees associated with “card not present” (CNP) credit card transactions due to fraud. Credit cards are processed through a network such as Visa®, MasterCard® or Discover®, making them subject to the brand's interchange fees and assessments. For the purposes of determining who does bear the risk of loss when a credit card is used without authorization, there is a difference if the transaction is one where the card is physically present or whether the card was not physically present (CNP). CNP fraud involves the unauthorized use of a credit or debit card number, the security code printed on the card (if required by the merchant) and the cardholder's address details to purchase product or services in a non-face-to-face setting such as over the Internet. Federal law in the United States limits the consumer's exposure for credit card fraud losses to $50. Generally, if a merchant accepts a credit card for a purchase and the card is physically present, the liability for loss fall on the card issuing financial institution, not the retail merchant. However, under certain card association rules, the risk of loss falls on the merchant in all CNP transactions. That means that the full value of a CNP purchase will be charged back to the merchant if the credit card turns out to be a fraud. For this reason, CNP transactions in currency exchanges is almost never entertained by the exchange operator because of the high risk involved.

Debit cards are processed depending on whether the debit card is present or not for the transaction. For signature (“offline”) debit transactions, the debit card is swiped like a credit card and the customer's PIN number is not entered. Instead of entering her PIN, the customer signs the sales receipt. Offline debit transactions are processed through networks owned by Visa®, MasterCard® or Discover® and are charged interchange fees and assessments.

In contrast, an online transaction occurs when a debit card is processed by allowing the customer to enter his/her PIN number. A PIN pad is required to process online debit transactions. Online debit transactions are processed through a PIN debit network instead of an interchange and are charged fees from the debit network that processes the transaction. Retail merchants can choose whether to use a PIN pad to accept online debit transactions since the customer is present to enter the PIN number. E-commerce merchants can only process offline debit transactions since the customer is not present to enter his/her PIN number.

Credit card interchange charges are greater than debit charges, and there are many more of them. Credit card charges also increase depending on the type of card (such as business or consumer) and the brand of card (such as rewards or standard). These variables can cause credit card transactions to be processed at 2.5% or more.

FinCEN is a bureau of the U.S. Department of the Treasury which is tasked with the mission to safeguard the financial system from illicit use and combat money laundering and promote national security through the collection, analysis, and dissemination of financial intelligence and strategic use of financial authorities. FinCEN carries out this mission by receiving and maintaining financial transactions data; analyzing and disseminating that data for law enforcement purposes; and building global cooperation with counterpart organizations in other countries and with international bodies. FinCEN exercises regulatory functions primarily under the Currency and Financial Transactions Reporting Act of 1970, as amended by Title III of the USA PATRIOT Act of 2001 and other legislation, commonly referred to as the “Bank Secrecy Act” (BSA). The BSA is a Federal anti-money laundering and counter-terrorism financing (AML/CFT) statute that requires banks and other financial institutions to take a number of precautions against financial crime, including the establishment of AML programs and compliance with governmental anti-fraud and money laundering (“AML”) measures as set forth in the USA Patriot Act, Section 326 Customer Identification Program (“CIP”); the rules of the Office of Foreign Assets Control (“OFAC”); and Know Your Customer (“KYC”).

KYC controls typically include the following;
Collection and analysis of basic identity information (referred to in US regulations and practice a “Customer Identification Program” or CIP);
Name matching against lists of known parties (such as “politically exposed person” or PEP) under OFAC rules;
Determination of the customer's risk in terms of propensity to commit money laundering, terrorist finance, or identity theft;
Creation of an expectation of a customer's transactional behavior;
Monitoring of a customer's transactions against their expected behavior and recorded profile as well as that of the customer's peers.

The CIP is intended to enable a bank to form a reasonable belief that it knows the true identity of each customer. The CIP must include account opening procedures that specify the identifying information that will be obtained from each customer. It must also include reasonable and practical risk-based procedures for verifying the identity of each customer. Banks should conduct a risk assessment of their customer base and product offerings.

The CIP rule applies to a “customer,” which is defined as “person” who opens a new account, an individual who opens a new account for another individual who lacks legal capacity, and an individual who opens a new account for an entity that is not a legal person (e.g., a civic club). The CIP must contain account-opening procedures detailing the identifying information that must be obtained from each customer. At a minimum, the following identifying information must be obtained from each customer before opening the account:
Name.
Date of birth for individuals.
Address.
Identification number.

The CIP must also contain risk-based procedures for verifying the identity of the customer within a reasonable period of time after the account is opened. The accuracy of every element of identifying information obtained does not need to be verified, but enough information must be verified to form a reasonable belief that the true identity of the customer is known. The procedures must describe whether documents, nondocumentary methods, or a combination of both will be used. The CIP must include procedures for determining whether the customer appears on any federal government list of known or suspected terrorists or terrorist organizations.

Furthermore, financial institutions must monitor transactions performed by or through them to comply with the economic and trade sanctions enforced by OFAC of the U.S. Department of the Treasury. All U.S. persons must comply with OFAC regulations, including all U.S. citizens and permanent resident aliens regardless of where they are located, all persons and entities within the United States, all U.S. incorporated entities and their foreign branches. OFAC acts under Presidential wartime and national emergency powers, as well as authority granted by specific legislation, to impose controls on transactions and to freeze assets under U.S. jurisdiction. Many of the sanctions are based on United Nations and other international mandates; therefore, they are multilateral in scope, and involve close cooperation with allied governments. Other sanctions are specific to the interests of the United States. OFAC has been delegated responsibility by the Secretary of the Treasury for developing, promulgating, and administering U.S. sanctions programs.

All U.S. persons, including U.S. banks, bank holding companies, and nonbank subsidiaries, must comply with OFAC's regulations. U.S. law requires that assets and accounts of an OFAC-specified country, entity, or individual be blocked when such property is located in the United States, is held by U.S. individuals or entities, or comes into the possession or control of U.S. individuals or entities. For example, if a funds transfer comes from offshore and is being routed through a U.S. bank to an offshore bank, and there is an OFAC-designated party on the transaction, it must be blocked.

Although not an exhaustive list, examples of products, services, customers, and geographic locations that may carry a higher level of OFAC risk include:
International funds transfers.
Nonresident alien accounts.
Foreign customer accounts.
Cross-border automated clearing house (ACH) transactions.
Commercial letters of credit and other trade finance products.
Transactional electronic banking.
Foreign correspondent bank accounts.
Payable through accounts.
International private banking.
Overseas branches or subsidiaries.

New accounts should be compared with the OFAC lists prior to being opened or shortly thereafter. OFAC checks performed after account opening should have procedures in place to prevent transactions, other than initial deposits, from occurring until the OFAC check is completed. Prohibited transactions conducted prior to completing an OFAC check may be subject to possible penalty action. In addition, policies, procedures, and processes should be in place to check existing customers when there are additions or changes to the OFAC list. Transactions such as funds transfers, letters of credit, and noncustomer transactions should be checked against OFAC lists prior to being executed.

### BRIEF SUMMARY OF THE INVENTION

The invention comprises a platform for conducting fully automated virtually instantaneous purchases and sales of digital currency such as bitcoin. The platform comprises automated account setup that validate the identity of the user without necessarily requiring manual submission of documentation such as proof of identity and proof of residency. Security checks performed as part of the automated account setup include IP security checks and CIP, AML and KYC compliance measures. The user must pass security checks and compliance checks before he/she can register with the platform.

The platform further comprises transaction validation measures that permit the user to fund his/her transactions on the platform. The transaction validation measures may include provision of credit card or debit card information, some of which may be stored by the platform, and issuance of a unique encryption key to the user that must be entered before the user can conduct transactions on the platform. The transaction validation measures further comprise such measures as the purchase of a dedicated secure card reader device that is associated with the user and with the provided credit/debit card; downloading of an application on the user's cell phone through which transactions can be performed on the platform; purchase of a device that attaches to any device via audio jack or USB port connectivity that processes credit card transactions on-location; setup of an account with a third party online person-to-person payment facilitator through which funds can be transferred between the user and the platform; use of third party services such as Verify by VISA® and MasterCard Secure Code® through which users can charge funds to a credit or debit card to fund transactions on the platform; the use of third party services through which users can charge funds to an e-wallet to fund transactions on the platform; and through the transfer of a digital image of a check along with a code issued by the platform for clearing of the check through the platform's bank.

The transaction validation measures when used together with the automated account setup qualifies credit card tractions as “card present” or “PIN debit over the Web” transactions for purposes of risk assessment by the merchant processor and consequently the fees charged by the merchant processors. Additionally, when used together these measures provide a user with the ability to register and virtually instantaneously fund transactions on the platform by using credit and debit cards.

Settlement methods further allow for virtually instantaneous settlement of funds between the platform and the user for sales of bitcoin to the platform. Settlement methods may comprise an ACH or Check 21 payment transaction to the user's bank account; issuance of a preloaded debit card to the user in the amount of the settlement; utilization of a third party online person-to-person payment facilitator to instantly disburse funds to the user's account with the payment facilitator by way of a wire transfer, an ACH or Check 21 transaction or a wire. The user may withdraw funds from the payment facilitator account by printing out a virtual check, wire, or transaction through Check 21. The platform may provide a seamless privately labeled gateway to the payment facilitator account so that any transactions with the payment facilitator are conducted from the platform website.

The platform is not an exchange in that it does not facilitate buy and sell transactions between users, but rather it purchases digital currency directly from, and sells digital currency directly to, its users. In conducting purchase and sales transactions, the platform purchases bitcoin from users at a set price and then sells that bitcoin on third party exchanges, or else purchases bitcoin on third party exchanges and sells it directly to the user.

A variety of other features can be provided through the platform. For example, merchants may obtain code to place on their website offering their customers to pay for purchases using bitcoin for online purchases. When the customer pays with bitcoin, the code redirects the bitcoin to a digital wallet set up on the platform for the merchant. The merchant can conduct transactions on the platform; transfer the bitcoin in its digital wallet on the platform to a personal digital wallet held outside of the platform; or convert some or all of the bitcoin into currency. This enables merchants with no merchant accounts to allow for users to pay with bitcoin purchased from the platform using their credit cards or debit cards.

The platform can provide a live video interface with the user that can enhance AML, CIP and KYC compliance, and to operate a biometric program to further enhance the platform's user validation procedures. The live video interface can be used to capture images of document(s) presented by the user, including identification document(s). Such images and documents can be used to facilitate the set-up of offshore banking accounts for users.

The platform may allow users to use gold or other commodity currencies to purchase or sell bitcoin.

The platform may offer users a purely bitcoin (or other digital) currency credit or debit card, and may provide a terminal download for a merchant's file that resides on the merchant's terminal which enables a merchant to accept the purely bitcoin credit or debit card using the platform's network. The user may be required to link a currency-based credit card or debit card to his/her account that can be pre-authorized for the transaction purchase amount so delays that can occur with transactions with bitcoin do not delay the merchant transaction.

The platform may offer users a credit line/stored value facility such that a user has a credit line in bitcoin to purchase products from merchants and to pay for those purchases using bitcoin.

The platform may be used for purchases and sales of various currencies and/or commodities. Users can conduct limit orders or enter into long or short option contracts with the platform. A limit order is an order from a user to purchase a specified amount of digital currency if the price of the digital currency falls within a specified purchase price range. If the purchase price of the digital currency falls within that specified purchase price range, the platform will execute the purchase to fulfill as much of the limit order as possible. A long option contract gives the user the right to buy digital currency at a set price before or on the expiration date of the contract. A short option contract creates an obligation on the part of the platform to sell digital currency to the user at a set price if the user exercises the option during the term of the contract.

Aspects of the invention can also be used individually or concurrently by exchanges that provide a P2P site for buyers and sellers to enter into direct buy and sell bitcoin transactions, such as the automated account validation process or the transaction validation measures. When used concurrently, exchanges are enabled to provide their customers virtually instantaneous purchases and sales of bitcoin by accepting credit or debit cards to fund online purchases while paying merchant processing fees for “card present” or “PIN debit on the web” services fees.

Although the description has been made in terms of digital currency and specifically bitcoin, the invention and no aspects of the invention are not so limited and nothing in this specification is intended to limit the invention to bitcoin or digital currency.

In one embodiment, the platform performs all purchase and sale transactions on a single website. In one embodiment, the platform performs all purchase transactions on one website and all sale transactions on a separate website. In one embodiment, the platform directs users to the purchase website or the sale website

The platform can be used in any country and with any commodities or currencies, including bitcoin or any other digital currency.

### DESCRIPTION OF THE DRAWINGS

The invention will be described with reference to the accompanying drawings, in which like elements are referenced with like numerals.

FIG. 1 is a block diagram of a platform for the purchase and sale of digital currency constructed according to one embodiment of the invention;

FIG. 2 is a block diagram showing the flow of information in conducting a transaction according to one embodiment of the invention.

FIG. 3 is a flow scheme of the automatic account validation feature according to one embodiment of the invention.

FIG. 4 is a flow scheme of the transaction validation methods according to one embodiment of the invention.

FIG. 5 is a flow scheme of a purchase transaction of bitcoin from the platform according to one embodiment of the invention.

FIG. 6 is a flow scheme of a sell transaction of bitcoin to the platform according to one embodiment of the invention.

FIG. 7 is a flow scheme of the use of a merchant “buy button” to purchase goods on a merchant website using bitcoin according to one embodiment of the invention.

### DETAILED DESCRIPTION OF THE INVENTION

The invention comprises a platform for conducting fully automated virtually instantaneous purchases and sales of digital currency. The platform comprises automated account setup; measures that qualify credit card transactions as “card present” or “PIN debit over the Web” transactions for purposes of risk assessment by the merchant processor and consequently the fees charged by the merchant processors; virtually instantaneous to access for purchases; virtually instantaneous settlement of funds to the user account holder for sales by use of a third party system that facilitates online person-to-person payments; and direct participation of the system operator in the purchase and sales transactions in a manner that allows the system operator to earn fees without requiring payment from the users. The platform can be used in any country and with any currencies.

Automated Account Validation.

In the platform of the invention, a variety of technological measures are combined with information provided by a potential user to set up and verify a platform account (prequalification) without necessarily requiring manual submission of documentation such as proof of identity and proof of residency. These steps are compliant with governmental anti-fraud and money laundering (“AML”) measures such as the USA Patriot Act, Section 326 Customer Identification Program (“CIP”); the rules of the Office of Foreign Assets Control (“OFAC”); and Know Your Customer (“KYC”). While there is no physical visit to a potential user or manual provision of documents by the potential user to the platform, state of the art mechanisms are used that are interfaced with the system in order to determine whether or not a particular potential user should be allowed to do business with the system under acceptable U.S. banking standards.

When a potential user contacts the platform and indicates he/she would like to register with the platform, information is acquired about the potential user both from the IP address of the potential user and also provided by the potential user. Actionable intelligence is acquired in real time from potential users contacting the platform via the Internet, which can be used to block security breaches and ecommerce fraud. For example, third parties can provide risk intelligence based on unique factors to an industry based on the user's IP address. This intelligence can be used to provide the “risk score” of a potential user that allows the platform to detect and block cyber threats and advanced malware before it enters the platform's network. Such potential users can be blocked from accessing the website in the future.

If the potential user is determined not to pose a risk threat, he/she is permitted to access the platform and seek registration. The platform acquires user-submitted information such as name, address and last 4 numbers of the Social Security Number (or other identifying information such as country identification number, as applicable). In one embodiment, this information is submitted to a third party which runs a verification check and determines whether the user meets qualifications that have been predetermined. In one embodiment, the platform runs the verification check based on the user provided information to determine whether the user meets predetermined qualifications. The platform then runs its own KYC, CIP and OFAC checks.

Potential users that achieve a pre-determined “score” under the aforementioned technological and policy measures (e.g., the potential users meet predetermined qualifications) may be permitted to register as a user of the platform. No manual submission of documents is required at least for potential users who achieve a pre-determined score. Manual review may be provided for potential users who score less than the pre-determined score before they can register as a user with the platform.

The platform can comply with all AML policies by automatically filing all required reports such as SAR and CTR to the respective databases of any applicable state and every country.

If the user at any point deletes his/her platform registration or is found at some point to fail the platform's security requirements, user data in the user data base may be deleted, or it may be retained for a predetermined amount of time before deletion. Platform 100 may retain some or all of the user data, or may delete some or all of the user data at routine intervals as part of a data maintenance program. In addition, some or all of the user data in the user data base may be encrypted. Some of the user data in the user data base may be hashed, or irreversibly encrypted.

Transaction Validation Measures.

As part of the registration process, the user provides credit and/or debit card information, some of which (such as the last 4 digits of the credit/debit card and the expiration date) is stored in a searchable database within the platform and associated with the user. As a further security measure, the user-provided credit/debit card information can be triangulated with information from third parties, such as with the user's IP address, to determine if any particular transaction will be permitted on the platform.

In one embodiment, each user that successfully registers is issued a unique encryption key by the platform that validates the user as verified under the CIP, OFAC and KYC measures instituted by the platform. For each transaction, the user is required to enter the unique encryption key which provides certainty that the user has been verified by the platform.

The user also selects one or more transaction validation measures.

In one embodiment, the user purchases a dedicated secure card reader device that is associated with the user in the searchable database and with the provided credit/debit card as a transaction validation measure. Transactions by that user on the platform can thereafter be conducted by running the provided credit/debit card through the dedicated secure card reader device. Typical credit/debit card authorization checks are run for each user transaction. Further, for each transaction, the user must affirmatively accept the Terms and Conditions of the platform that are displayed on the screen, which acceptance is recorded in the searchable database in connection with that transaction and the user. The Terms and Conditions set forth rules that the user agrees to comply with such as refund policy, standards of conduct and legal issues such as applicable law and venue.

In one embodiment, the user can download an application on his/her cell phone through which transactions can be performed on the platform as a transaction validation measure. When the user initiates a transaction on the platform, the application validates the user through text messaging and validation by the user's cell phone carrier. The application may be operated by a third party. The application mimics a card present transaction for a credit card and a PIN debit transaction for a debit card.

In one embodiment, the transaction validation measure comprises a device that the user can purchase that processes credit card transactions on-location as a transaction validation measure. Such devices can attach to any device via audio jack or USB port connectivity.

In one embodiment, a user can load funds into an account the user has with existing third party services, such as a third party online person-to-person payment facilitator, as a transaction validation measure. This may include, for example, depositing funds at a local bank into the master bin of the payment facilitator account which can then be used to fund user's transactions on the platform. In one embodiment, the user deposits a check into the master bin of the payment facilitator account and the local bank creates a negotiable instrument called a substitute check under the Check 21 Act. The substitute check is the legal equivalent of the original check and includes all the information contained on the original check. In one embodiment, the user performs an ACH payment transaction to fund the user's payment facilitator account. An ACH payment transaction consists of (1) an instruction of a sender to a bank to pay, or to obtain payment of, or to cause another bank to pay or to obtain payment of, a fixed or determinate amount of money that is to be paid to, or obtained from, a receiver, and (2) any and all settlements, accounting entries, or disbursements that are necessary or appropriate to carry out the instruction. In one embodiment, the user wires money into his/her payment facilitator account. The user then directs the payment facilitator to transfer funds from his/her account to the platform.

In one embodiment, the user acquires a digital image of a check written on his or her account picture of the check, then sends the image to a specified email address that is tied to his or her account for clearing of that check through the platform's bank. The user then uploads the image of the check to the platform using a specified code that he/she requests from the platform. Thereafter, the user send the image of the check by text to a number given to the user by the platform.

In one embodiment, the transaction validation measure comprises third party services such as Verify by VISA® and MasterCard Secure Code® through which users can charge funds to a credit or debit card, which funds can then be used to fund his/her transactions on the platform.

In one embodiment, the transaction validation measure comprises third party services through which users can charge funds to an e-wallet using a credit or debit card. Users can then use funds in the e-wallet to fund his/her transactions on the platform.

These transaction validation measures in conjunction with the automatic account validation measures qualify the transaction as a “card present” credit card transaction or a “PIN debit over the web” transaction, lowering the risk to the merchant processor and therefore lowering the processing fees that must be paid by the platform to the merchant processor for funding of user accounts through the use of credit cards and debit cards. The additional requirement that the user enter his/her unique encryption key provides further certainty to merchant processing gateways that the user has been verified by the platform.

Instant Purchase of Bitcoin.

Any one of these methods or any combination of these methods can be used to essentially instantaneously fund user transactions so that the user can engage in transactions on the platform. For methods that do not require the physical acquisition of a device, the user can begin engaging in transactions virtually instantly after signing up, being automatically validated by the platform and setting up one or more transaction validation measures. If the user acquires a physical device as a transaction validation measure, transactions after that point can be instantly funded to purchase or sell digital currency on the platform. There may initially be limits on dollar (or other currency) amounts of transactions that a user can conduct until certain predetermined conditions are met (such as amount of time the user has had the account). This allows a user to purchase the bitcoin, digital currency or other commodities in essentially real time without being subject to market fluctuations that can occur while waiting for funding to take place in exchanges.

Instant Settlement of Funds.

The platform can virtually instantly settle funds with users for sales of bitcoin, currency or other commodities to the platform. In one embodiment, the platform performs an ACH payment transaction to fund the user's bank account. All parties to an ACH transaction are subject to the requirements of OFAC which are satisfied by the validation measures taken by the platform in registering a user and validating any individual transaction.

In one embodiment, the platform issues a preloaded debit card in the amount of the settlement. The debit card may be instantaneously provided as a virtual card that can be used immediately, and a hard copy of the debit card may later be sent to the user.

In one embodiment, the platform utilizes a third party online person-to-person payment facilitator to instantly disburse funds to users. An account is set up for each user with the payment facilitator. When a transaction occurs, the platform funds the user's account with the payment facilitator in the amount to be settled for a transaction. The platform may fund the user's payment facilitator account by means of a wire transfer, an ACH transaction or a Check 21 substitute check. These funds are then instantaneously available to the user through his/her payment facilitator account. To withdraw the funds from the payment facilitator account, the user may print out a virtual check and deposit it with his/her bank. The user may wire money from his/her account with the payment facilitator to any other account. In one embodiment, the payment facilitator may issue a check from its master account for deposit at the user's local bank from which the local bank creates a substitute check under the Check 21 Act. In one embodiment, the platform provides a seamless privately labeled gateway to the payment facilitator account so that any transactions with the payment facilitator may be conducted from the platform website.

Alternative Medium of Bitcoin Transactions.

In the invention, the platform operator is a party to each transaction. Each day, or at any other desired intervals including real time, the platform analyzes buy and sell prices of bitcoin on a plurality of third party bitcoin exchanges. Using that information, the platform sets a sell price that allows the platform to purchase bitcoin from third party exchanges at one price and then sell bitcoin to its users at a higher price than it purchased that bitcoin. Further using that information, the platform sets a buy price that allows the platform to purchase bitcoin from its users at one price and then sell bitcoin at a higher price to third party exchanges. The mark-up (or mark-down) of bitcoin buy and sell pricing allows the platform to cover its operating costs and provide a margin without charging user fees. The platform can also allow users to enter limit orders to allow users to enter buy/sell transactions if or when bitcoin reaches certain price levels set out in the limit order. In addition, or alternatively, the platform can charge user fees for buy and sell transactions conducted on its website.

In one embodiment, the platform allows users to take long or short positions with bitcoin or other digital currencies, or any other commodity or currency. The user can enter into a contract with the platform where the user has the right but not the obligation to purchase an agreed quantity of a particular commodity such as bitcoin or other digital currency from the platform by a certain time for a certain price. The platform is obligated to sell the commodity to the user if the user exercises his/her option. The user pays a fee to the platform for this right. The user can also enter into a contract with the platform giving the user the right to buy the commodity from the platform any time before the option expires for which the user pays a fee to the platform. In either case, the platform keeps the fee whether or not the user ever exercises his/her option.

The following describes the process when a user purchases bitcoin from the platform. First, the user logs on to the platform by entering a password. The password can comprise alphanumeric characters, special characters, biometric information or combinations thereof. The platform conducts a security check based on the user's IP address. If the user enters the correct logon information and passes the security check, the user may be required to enter his/her unique encryption key. Once the unique encryption key is verified as correct, the user may conduct transactions on the platform. For example, the user may elect to purchase bitcoin at the stated sell price of the platform. To purchase bitcoin, the user must affirmatively accept the Terms and Conditions of the platform, which acceptance is recorded in connection with that purchase transaction. The platform preauthorizes the purchase amount according to the user's selected transaction validation measure. For example, if the user elects to use a secure card reader device as a transaction validation measure, the user swipes a credit card or debit card using the secure card reader device and the platform preauthorizes that the amount of the purchase is available to be charged to that credit card or debit card. Once acceptance of the Terms and Conditions and preauthorization of the purchase amount is completed, the platform creates a temporary digital wallet for this transaction to transfer bitcoin to that temporary wallet. The platform's digital wallet sends a digitally signed message to the Bitcoin network, specifying the temporary digital wallet address and the amount of bitcoin to be transferred in the amount of the purchase by the user. The Bitcoin network validates, or confirms, the transaction and the bitcoin is transferred to the temporary digital wallet created by the platform. The platform then initiates the funds transfer according to the user's transaction validation measure to transfer funds to the platform's currency account in the amount of the purchase. Once confirmation of the funds transfer is complete, the platform transfers the bitcoin from the temporary digital wallet to the user's personal digital wallet. The temporary digital wallet is then deleted.

When a user wants to sell bitcoin to the platform, in a first transaction the user must agree to the purchase price stated on the platform at that time and affirmatively accept the Terms and Conditions of the platform, which acceptance is recorded in connection with that sale transaction. The platform creates a temporary digital wallet for the transaction. The user has his/her personal digital wallet send a digitally signed message to the Bitcoin network, specifying the temporary digital wallet address and the amount of bitcoin to be transferred in the amount of the sale by the user. The Bitcoin network validates, or confirms, the transaction and the bitcoin is transferred to the temporary digital wallet. Once the transfer of bitcoin from the user to the temporary digital wallet has been confirmed, the platform settles the user transaction by transferring funds to the user in a manner selected by the user. The platform then transfers bitcoin from the temporary digital wallet into the platform digital wallet. The temporary digital wallet is then deleted.

In one embodiment, the user transfers his/her bitcoin to the digital wallet of the platform rather than a temporary digital wallet.

The platform can purchase bitcoin from third party exchanges to satisfy user purchases in real time or periodically on any basis desired. For example, the platform may purchase bitcoin from third party exchanges every hour; every 2 hours; twice a day; or may determine when to purchase bitcoin on other factors such as fluctuations in price and purchase/sale volume on its own site. All traffic to and from the third party bitcoin exchanges is encrypted to further ensure security of authentication. The platform can also sell bitcoin that it has purchased from users on third party exchanges. Sales may be conducted at any time interval, for example every hour; every 2 hours; twice a day; or may determine when to purchase bitcoin on other factors such as fluctuations in price and purchase/sale volume on its own site. All traffic to and from the third party bitcoin exchanges is encrypted to further ensure security of authentication.

Other Features.

The platform has other features that may be implemented alone or in combination with the previously described features. For example, merchants may offer bitcoin to its customers as a payment option for online purchases. In this embodiment, a merchant can obtain code for a “buy button” from the platform that it places on its own website. The “buy button” can comprise code that allow the location of the “buy button” on the Internet to be determined by a “ping” command. This provides additional security in allowing the platform control over the sites that the “buy button” is placed, making sure that they are not being used on illicit or undesirable sites. The platform then sets up a permanent digital wallet for the merchant. The merchant permanent digital wallet is permanent while the merchant is associated with the platform. This “permanent” digital wallet can be deleted at any time.

When users of the merchant site want to pay for a purchase from the merchant, the user has the option to click on the merchant “buy button” which redirects the user to the platform. If the user already has an account with the platform, he/she can log in and pay for his/her purchase in bitcoin. The user may be asked to enter his/her unique encryption key as an additional validation measure. The code in the “buy button” instructs the user's personal digital wallet to send a digitally signed message to the Bitcoin network, specifying the address of the merchant's digital wallet address that was created by the platform and the amount of bitcoin to be transferred in the amount of the purchase from the merchant. The Bitcoin network validates, or confirms, the transaction and the bitcoin is transferred from the user's personal digital wallet to the merchant's digital wallet on the platform. In one embodiment, the user transfers bitcoin to the platform's digital wallet, and the platform then transfers the bitcoin to the merchant's digital wallet on the platform. The merchant can then conduct transactions on the platform including sale of the bitcoin in its digital wallet. The merchant can also transfer the bitcoin in its digital wallet on the platform to a personal digital wallet held outside of the platform. In one embodiment, the merchant can select options on an administrative panel within the platform to convert some or all of the bitcoin received from the user into currency and for the platform to settle with the merchant by transferring funds using any of the settlement methods previously described.

In one embodiment, the user can conduct an immediate transaction with the platform using his/her credit card or debit card to purchase sufficient bitcoin from the platform to pay for the purchase from the merchant. The bitcoin is then transferred to the digital wallet of the merchant as previously described. Once the transaction is completed, the user is redirected back to the merchant site. The entire process can be completely automated unless the user is not yet registered with the platform, in which case the user must register and pass the validation and security checks as required of any potential user.

In one embodiment, the platform sets up a temporary digital wallet for the user to transfer the bitcoin for the purchase. The bitcoin can then be pushed into the merchant's permanent digital wallet which is located on the platform.

This embodiment is useful for merchants who do not have their own merchant account because their customers are enabled to use their credit cards and debit cards to indirectly pay for purchases from the merchant by purchasing bitcoin from the platform using the credit card or debit card.

The platform may further be used for purchases and sales of various currencies and/or commodities. Although the description has been made in terms of digital currency and specifically bitcoin, the invention and no aspects of the invention are not so limited and nothing in this specification is intended to limit the invention to bitcoin or digital currency.

Aspects of the invention can also be used individually or concurrently by exchanges that provide a P2P site for buyers and sellers to enter into direct buy and sell bitcoin transactions, such as the automated account validation process or the transaction validation measures. When used concurrently, exchanges are enabled to provide their customers virtually instantaneous purchases and sales of bitcoin by accepting credit or debit cards to fund online purchases while paying merchant processing fees for “card present” or “PIN debit on the web” services fees. Exchanges can similarly utilize the fund settlement methods previously described alone or in combination with the automated account validation process and/or the transaction validation measures.

The platform can provide a live video interface with the user. One purpose for the live video interface is to satisfy KYC compliance. The platform may require a potential user to enable his/her camera when he/she registers. In one embodiment, the user may give permission in the Terms and Conditions allowing the platform to remotely operate the user's camera for certain reasons, such as transactions exceeding a certain value or to conduct random checks. The platform can operate a biometric program that will provide a score regarding the user's identity that must be satisfied within an acceptable predetermined range before the potential user is permitted to register. In one embodiment, the video interface is utilized after the potential user has been validated with risk screening and security checks including IP address checks and OFAC, KYC and CIP checks. In one embodiment, the live video interface allows the platform to capture an image of document(s) presented by the user, including identification document(s) in addition to the image of the user presenting the document(s) which can be stored in the searchable database of the platform. In one embodiment, the live video interface allows for live operator support by video. The platform may charge for the live video support, or it may provide live video support for free. For example, for live video support relating to payments or transactions, the live operator video support may be provided at no charge to the user. Live operator technical support by video may be available at a charge to the user.

In one embodiment, the platform may facilitate the set-up of offshore banking accounts for users. In this embodiment, the platform may utilize its security validation measures along with its live video capabilities to obtain the necessary identification and other documentation required to set up an offshore bank account. For example, the platform's compliance with KYC, CIP and OFAC and live data registration with live video operators can assist potential offshore account holders through the account opening process. Using the live video capabilities, required ID credentials via live support operators who can take a picture of the ID credentials can be captured. Similarly, the live video can obtain the biometric profile of the potential account holder as well as take a photograph of the potential account holder to be stored with due diligence documentation. The exact IP address of the potential account holder at their stated residence can also be obtained and stored. The platform can also assist on a pay per service model for assisting its users with offshore banking transactions.

In one embodiment, bitcoin may be exchanged for gold using pawnshops and/or online gold traders. Gold and other precious metals, such as silver, platinum and palladium, are considered a form of currency and can be traded in a similar manner to currency. This embodiment can be particularly useful in countries having foreign exchange controls on the purchase/sale of foreign currencies by residents or on the purchase/sale of local currency by nonresidents.

Countries with foreign exchange controls are also known as “Article 14 countries,” after the provision in the International Monetary Fund agreement allowing exchange controls for transitional economies. In such countries, the platform can facilitate trades for gold at its spot value and transfer the equivalent in bitcoin to the user's digital wallet without invoking the foreign currency controls. The user must deliver the gold or other currency to a trusted trader or pawn shop. Once delivery is confirmed and the value of the delivered gold is confirmed, the platform can accept the gold as payment for transactions. The gold can then be sold online and funds transferred to the platform's currency account. Alternatively, the platform may purchase gold from a trusted third party such as a pawn shop or online gold trader and transfer that gold to the user to settle funds. Other commodities can also be used, such as silver, platinum, palladium, diamonds, or any other precious metals, precious gems or semi-precious metals or semi-precious gems.

In one embodiment, the platform enables users to have a purely bitcoin (or other digital) currency credit or debit card. In one embodiment, the platform may provide a terminal download for a merchant's file that resides on the merchant's terminal which enables a merchant to accept a purely bitcoin credit or debit card using the platform's network. Typical transaction measures are conducted for any such credit card or debit card transaction. In one embodiment, the platform further performs validation measures as previously described to confirm that the bitcoin associated with the debit card has not previously been spent elsewhere prior to accepting bitcoin for a purchase. Once the merchant purchase transaction is approved, bitcoin is debited from the user's platform account associated with the debit card and then transferred to the digital wallet of the merchant. In one embodiment, the credit card or debit card is virtual.

For use of a bitcoin credit card, the amount of bitcoin that is charged to the user's bitcoin credit card is the amount of bitcoin that can be purchased at the platform's current purchase price equivalent to the amount of the purchase from the merchant. The platform transfers that amount of bitcoin to the merchant's digital wallet. In one embodiment, the user can deposit bitcoin with the platform to pay off the balance in accordance with the terms agreed to when the credit card was issued or in accordance with amendments to the terms. In one embodiment, the user can deposit funds or other type of currency (such as gold) with the platform to pay off the balance of the credit card.

In one embodiment, the platform requires that the holder of a pure bitcoin (or other digital currency) credit card or debit card account link a currency-based credit card or debit card to that account. When the user seeks to perform a transaction using his/her bitcoin credit card or debit card, the platform simultaneously pre-authorizes the linked currency-based credit card or debit card for the transaction amount. If there are delays in processing the bitcoin, the transaction can take place without delay based on the pre-authorization using the currency-based credit card or debit card.

In one embodiment, the platform comprises a credit line/stored value facility such that a user has a credit line in bitcoin to purchase products from merchants and to pay for those purchases using bitcoin. Stored value facilities are prepaid instruments that can be used for the payment of goods or services up to the amount that has been stored in the instrument. A single-purpose stored value facility can only be used to pay for goods and services provided by its issuer. A multi-purpose stored value facility can be used for the purchase of goods and services provided by its issuer as well as other parties. In one embodiment, the user transfers bitcoin to the platform. The transferred bitcoin amount is associated with the user's platform account and can be used to pay for purchases from third party merchants using the bitcoin stored value facility. Upon completion of a purchase with a merchant, bitcoin in the monetary amount equivalent to the purchase amount is transferred from the platform digital wallet to the merchant digital wallet. This amount of bitcoin is also debited from the amount associated with the user's platform account.

For use of a bitcoin credit line, the amount of bitcoin that is charged to the user's bitcoin credit line is the amount of bitcoin that can be purchased at the platform's current buy price equal to the amount of the transaction with the merchant. The platform transfers that amount of bitcoin to the merchant's digital wallet. In one embodiment, the user can transfer bitcoin to the platform to pay off the balance in accordance with the terms agreed to when the credit line was set up or in accordance with amendments to the terms. In one embodiment, the user can deposit funds or other commodities (such as gold) with the platform to pay off the balance.

If necessary, the platform can purchase bitcoin from bitcoin exchanges to maintain sufficient bitcoin for credit card and credit line transactions.

In one embodiment, the platform performs all purchase and sale transactions on a single website. In one embodiment, the platform performs all purchase transactions on one website and all sale transactions on a separate website. In one embodiment, the platform directs users to the purchase website or the sale website from a common landing page.

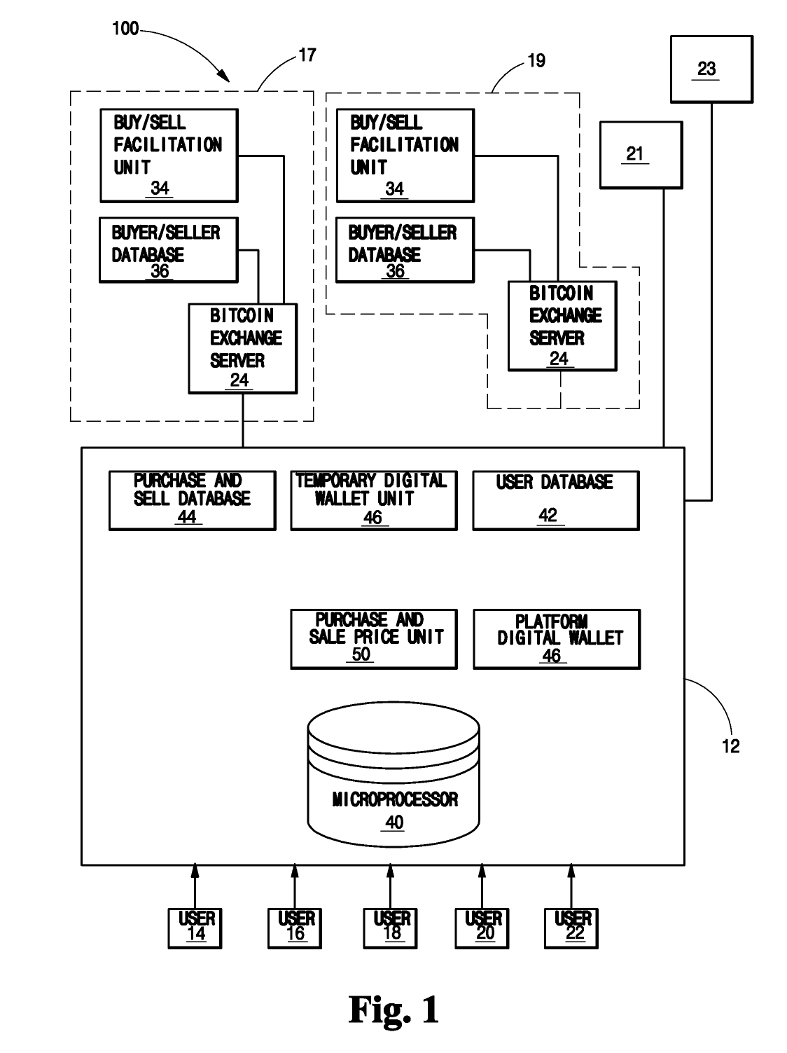

Turning to the figures, FIG. 1 is a block diagram of a platform 100 for purchases and sales of digital currency according to one embodiment of the invention. In this embodiment, the platform 100 comprises a single website for all transactions. This is exemplary of this embodiment only, and is not intended to limit the invention in any manner. Platform 100 may comprise separate websites to conduct different transactions.

Platform 100 comprises a platform server (PS) 12, a plurality of users 14, 16, 18, 20, 22 being connected to the PS 12 to execute purchases and sales of digital currency. The connections between the users 14, 16, 18, 20, 22 and PS 12 may be provided by secure telephone lines, via the Internet or any other similar means. The users 14, 16, 18, 20, 22 may be individual user, small or large traders, etc., each having a PC or other means of accessing PS 12, such as a smart or a dumb terminal.

Also connected to the platform server 12 are a plurality of third party operated bitcoin exchanges 17, 19, 21, 23. The bitcoin exchanges 17, 19, 21, 23 typically facilitate the exchange of bitcoins between their own users on their own platforms. Each bitcoin exchange typically comprises a server 24, a buyer and seller database 36 and a buy/sell facilitation unit 34.

PS 12 comprises a microprocessor 40 which performs all the data processing associated with the functions of PS 12. In addition, PS 12 further includes a user data base 42, a purchase and sale data base 44, a temporary digital wallet unit 46, a platform digital wallet 48, and a buy and sell pricing unit 50.

Before a user can access the platform 100, he/she must register with the platform. User registration and validation is typically performed through PS 12, although this function may be outsourced to one or more third parties.

Once a user is registered and validated, his/her profile, including name, address, password, partial credit/debit card information and other data is stored in user data base 42 and associated with the user. The user may be issued a unique encryption key that must be entered before the user can conduct transactions on the platform. The user then selects one or more transaction validation measures to be implemented to fund each buy transaction the user will perform on the platform 100. Transaction validation measures include but are not limited to purchase of a dedicated secure card reader device that is associated with the user and with the provided credit/debit card; downloading of an application on the user's cell phone through which transactions can be performed on the platform; purchase of a device that attaches to any device via audio jack or USB port connectivity that processes credit card transactions on-location; setup of an account with a third party online person-to-person payment facilitator through which funds can be transferred between the user and the platform; use of third party services such as Verify by VISA® and MasterCard Secure Code® through which users can charge funds to a credit or debit card to fund transactions on the platform; use of third party services through which users can charge funds to an e-wallet to fund transactions on the platform; and through the transfer of a digital image of a check along with a code issued by the platform for clearing of the check through the platform's bank. This list of transaction validation measures is not intended to limit the invention in any manner. Any other methods that can be validated that are now known or later developed may also be used in accordance with the principles of the invention.

If the user is interested in buying bitcoin from the platform, he/she must provide funds using one or more the user's transaction validation measures. The availability of the funds are determined by the platform before the user can conduct transactions on the platform.

The user also sets up one or more fund settlement methods. In one embodiment, the fund settlement method comprises an ACH transaction with a user's bank account. In one embodiment, the fund settlement method comprises issuance of a preloaded debit card in the amount of the settlement. In one embodiment, the fund settlement method comprises utilizing a third party online person-to-person payment facilitator and instantly disbursing funds to the user's account with the payment facilitator by way of a wire transfer, an ACH transaction or a Check 21 substitute check or a wire. The user may withdraw funds from the payment facilitator account by printing out a virtual check, wire, or issuance of a substitute check. The platform may provide a seamless privately labeled gateway to the payment facilitator account so that any transactions with the payment facilitator are conducted from the platform website.

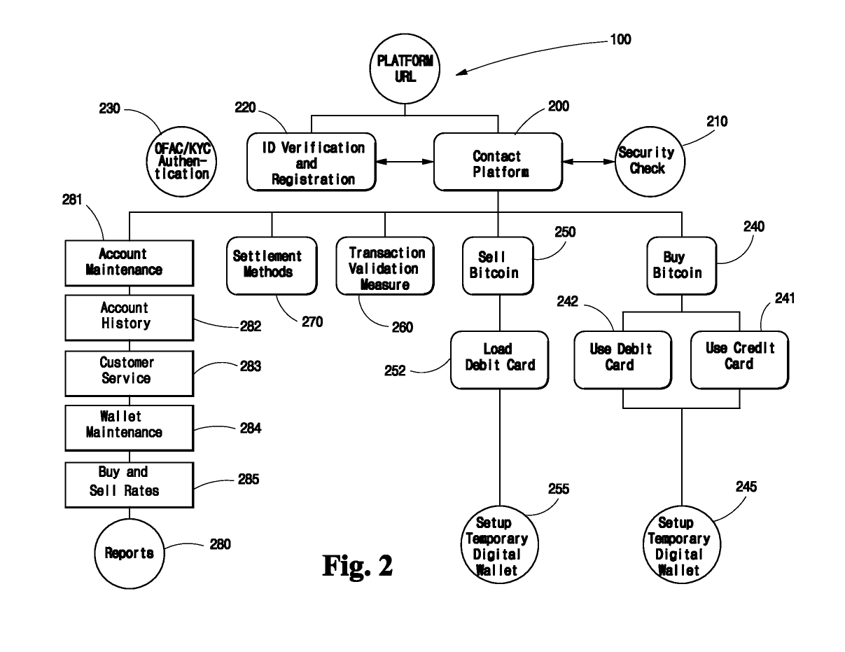

The process of user registration to allow a user to conduct a buy or sell transaction on the platform 100 is shown in FIG. 2. At 200, the potential user contacts platform 100 using a standard PC or other similar device and attempts to sign on to get access to the platform 100. At 210, platform 100 first conducts a security check based on information acquired in real time from the potential user's session with the platform 100 such as IP address. Third parties provide risk intelligence based on unique factors based on the potential user's IP address. This intelligence can be used to provide the “risk score” of the potential user that allows the platform to detect and block cyber threats and advanced malware before it enters the platform's network. If this initial check does not meet certain predetermined conditions, the potential user may be blocked from accessing the platform 100. For example, if the potential user IP address appears to be related to known fraudulent Internet activity, the potential user may be blocked from communicating with the platform for that session or the potential user may be permanently blocked.

If the potential user passes the initial security check at 210, he/she is permitted to register at 220 and platform 100 sends a request to the potential user to provide identification information. The potential user's PC can provide some or all of this information automatically or the information may be entered manually by the potential user. As part of the registration process, the potential user selects a password which is stored in the user data base 42. The platform 100 may request that the potential user turn on the camera on his/her PC and record the image of the potential user and documentation such as identification documents.

In this embodiment, platform 100 submits queries to a third party based on the potential user-provided information, such as name, address and last 4 numbers of the Social Security Number (or other country identification number, as applicable). The third party runs the verification check and replies whether the potential user meets qualifications that have been predetermined by platform 100.

If the potential user meets certain qualifications at 220, platform 100 runs its own KYC, CIP and OFAC checks at 230. Potential users that achieve a pre-determined “score” under the aforementioned policy and technological measures are permitted to register and set up a platform account with platform 100 after accepting the platform's Terms and Conditions. No manual submission of documents is required for validation at least for potential users who achieve a pre-determined score. Manual review may be provided for potential users who earn less than the pre-determined score before they can set up a platform account. Platform 100 may issue the potential user a unique encryption key to be entered when he/she wants to conduct transactions.

Once the user is validated and is permitted to register with platform 100, he/she logs in to platform 100 at 200. Platform 100 may conduct a security check at 210 based on information gleaned from the user's IP address before permitting the user to access the logon screen. If the user passes the security check, platform 100 sends to the user PC a welcome screen which is rendered by the user's browser for display on the user's screen of his/her PC or other device. On the welcome screen, the user is provided with various information which may be tailored to his/her needs and his/her personal profile. For example, the screen may display a list of the recent transactions or a watch list of buy/sell prices. A Help section may also be accessed from the welcome screen. A section may also allow the user to monitor the progress and status of his/her transactions. The user can initiate a buy/sell transaction from the welcome screen. These features are merely exemplary and many other variations and formats may be used to provide the information and options to the user, such as live video support.

The user initially must set up one or more transaction validation measures at 260 and one or more fund settlement methods at 270.

Once the welcome screen is shown, the user may initiate a buy or sell transaction. For example, the user may review a watch list and choose to buy or sell depending on the buy/sell prices shown on the posted buy and sell price list. If this choice is made, a trade screen is displayed that allows the user to purchase or sell bitcoin at the rate advertised by platform 100 for that time and date. In one embodiment, the user may set up a limit order to buy or sell if bitcoin prices reach a certain level. The user may elect to enter into an options contract with the platform to purchase or sell bitcoin at a date in the future at a set price. The process performed by the platform 100 depends on the nature of the user selection.

At 240, platform 100 receives a purchase transaction request from a user who accepts the Terms and Conditions of the transaction. Platform 100 confirms the transaction validation measure that the user intends to use to fund the transaction. For example, the user may elect to use as the transaction validation measure a credit card at 241 or a debit card 242 to cover the cost of the transaction. If the user set up more than one transaction validation measure, the user can select one or more to utilize to fund that particular transaction. At 245, platform 100 sets up a temporary digital wallet for the transaction and transfers bitcoin to the temporary digital wallet. Platform 100 initiates a funds transfer according to the transaction validation measure selected by the user at 260. Once the funds transfer is confirmed, platform 100 initiates a bitcoin transfer from the temporary digital wallet created at 245 to the user's private digital wallet.

At 250, platform receives a sell request from a user. At 255, the user agrees to sell bitcoin to platform 100 at the sell price listed at that time and date by platform 100 and accepts the Terms and Conditions of the transaction. Platform 100 confirms the settlement method that the user intends to use to settle the transaction. For example, the user may elect to use as the settlement method a loaded debit card at 252. If the user set up more than one settlement method, the user can select one or more to utilize to settle that particular transaction. At 255, platform 100 sets up a temporary digital wallet for the transaction and the user transfers bitcoin to the temporary digital wallet. Platform 100 initiates a bitcoin transfer from the temporary digital wallet created at 255 to the platform digital wallet. Once the bitcoin transfer is confirmed, platform 100 initiates a transfer of funds according to the settlement method(s) selected by the user at 270.

Every purchase of bitcoin, whether from users or from third party bitcoin exchanges, is validated by the Bitcoin network prior to transfer of funds to or from platform 100.

At predetermined intervals, platform 100 searches to see if limit orders placed by users match the purchase or sell price offered by platform 100. If the transaction is a limit order, platform 100 follows this same process except that it checks that the transaction amount is authorized using the user's transaction validation measure or that the amount of bitcoin that the user has transferred to the platform digital wallet will cover the limit order. If not, platform 100 will send a message to the user notifying him/her that the limit order was not completed. Platform 100 may also check if users have exercised their options under any options contracts and conduct the transactions accordingly.

At 280, platform 100 offers a number of administrative services such as account maintenance at 281; account history at 282; customer service at 283; wallet maintenance at 284; and bitcoin exchange rates at 285. Users can access these services and, for example, add or delete a transaction validation measure, enter a limit order or enter into an options contract.

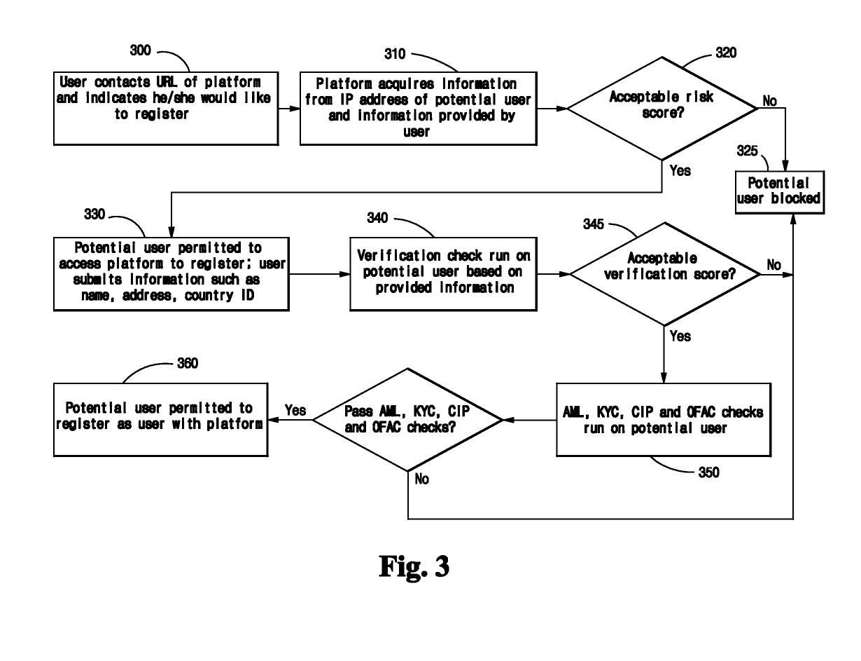

FIG. 3 is a flow scheme of the automatic account validation feature according to one embodiment of the invention. At 300, a potential user contacts platform 100 and indicates he/she would like to register. At 310, platform 100 acquires information from the IP address of the potential user and also provided by the potential user. At 320, platform 100 determines a “risk score” of the potential user. Potential users that achieve an acceptable risk score are permitted to continue. At 325, potential users that do not achieve an acceptable risk score can be blocked from accessing the website in the future. At 330, potential users with acceptable risk scores are permitted access to platform 100 to register. The potential user submits information such as name, address and last 4 numbers of the Social Security Number (or other identifying information such as country identification number, as applicable) to platform 100. At 340, a verification check is run based on information about the potential user. If the potential user does not achieve a predetermined score, at 325 the potential user is denied further access to platform 100. At 350, AML, KYC, CIP and OFAC checks are run on potential users who achieve the predetermined score at 345. At 360, potential users that achieve a pre-determined “score” under the aforementioned technological and policy measures are permitted to register as a user of platform 100. Potential users that do not pass the AML, KYC, CIP and OFAC checks are denied further access to platform 100 at 325.

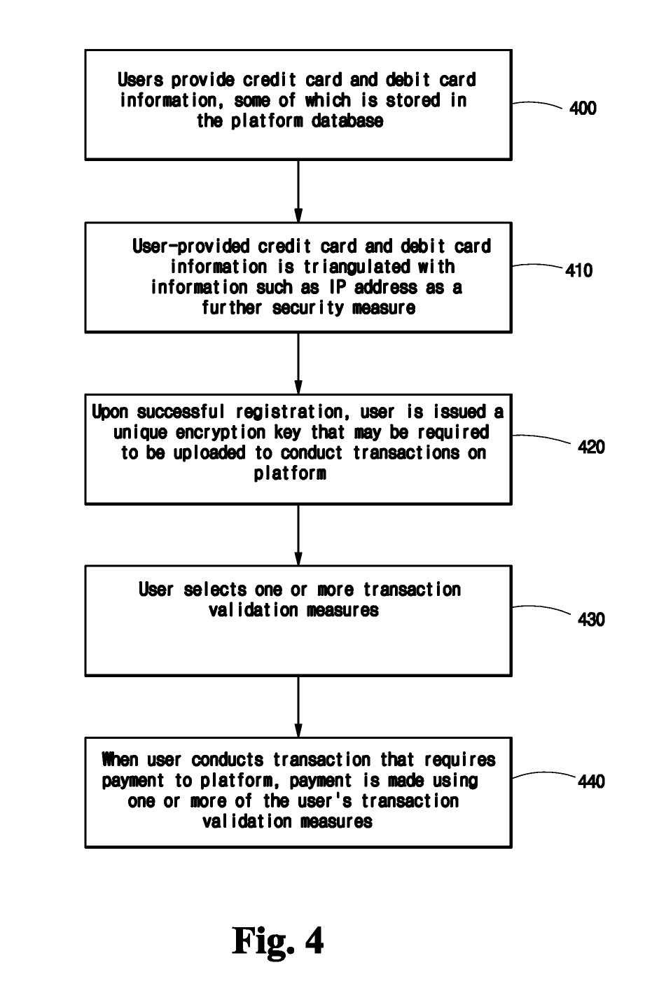

FIG. 4 is a flow scheme of selection of transaction validation methods according to one embodiment of the invention. At 400, users who are permitted to register must provide credit card and/or debit card information, some of which is stored in a searchable database within platform 100 and associated with the user. At 410, as a further security measure, the user-provided credit/debit card information optionally can be triangulated with information from third parties, such as with the user's IP address, to determine if any particular transaction will be permitted on platform 100. At 420, each user that successfully registers is issued a unique encryption key by platform 100. When the user logs onto platform 100 in the future or otherwise attempts a transaction with platform 100, the user may be asked to upload the unique encryption key as further validation that the user was verified under the CIP, OFAC and KYC measures instituted by platform 100. At 430, each user selects one or more transaction validation measures. The transaction validation measures include purchase of a dedicated secure card reader device that is associated with the user and the provided credit/debit card in the database of platform 100; downloading of an application on his/her cell phone through which transactions can be performed; purchase of a device that processes credit card transactions on-location that attach to any device via audio jack or USB port connectivity; loading of funds into an account the user has with existing third party services, such as a third party online person-to-person payment facilitator; charging funds to a credit card or debit card using third party services such as Verify by VISA® and MasterCard Secure Code®; charging funds to a credit card or debit card to fund an e-wallet through a third party; and through the transfer of a digital image of a check along with a code issued by the platform for clearing of the check through the platform's bank. At 440, when the user later conducts a transaction on platform 100 that requires payment from the user, platform 100 obtains payment using one or more of the user's selected transaction validation measures.

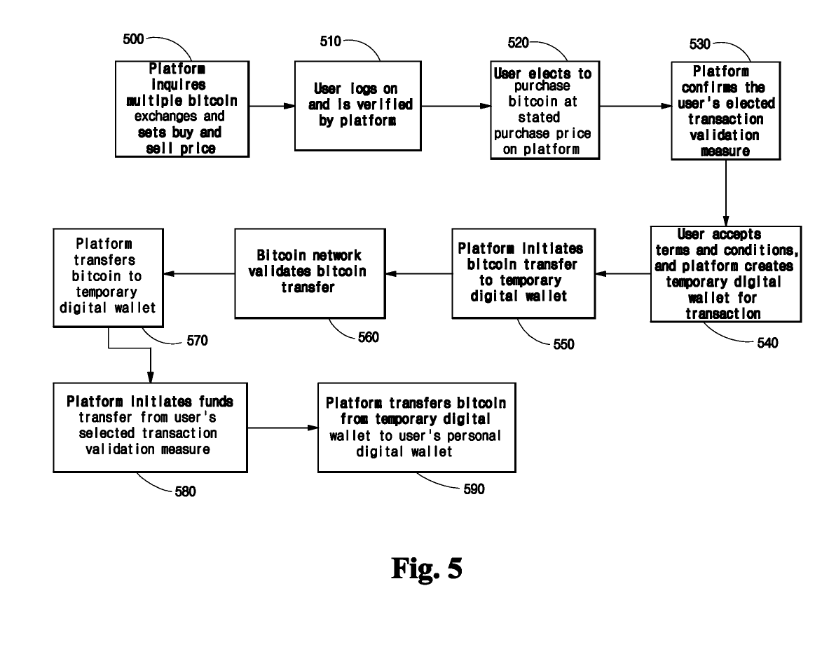

FIG. 5 is a flow scheme of a purchase transaction of bitcoin from platform 100 according to one embodiment of the invention. At 500, platform 100 makes inquiries at a plurality of third party bitcoin exchanges and determines a buy price and a sell price for bitcoin. At 510, a user logs on to platform 100 and platform 100 runs a security check based on the user's IP address. The user may be required to enter his/her unique encryption key. At 520, if the user successfully logs on, the user elects purchase bitcoin at the stated sell price of platform 100. At 530, platform 100 confirms the user's selected transaction validation measure. For example, if the user elects to use a secure card reader device as a transaction validation measure, the user swipes a credit card or debit card using the secure card reader device and the platform preauthorizes that the amount of the purchase is available to be charged to that credit card or debit card. At 540, the user affirmatively accepts the Terms and Conditions of platform 100, which acceptance is recorded in connection with that purchase transaction. At 550, once acceptance of the Terms and Conditions and preauthorization of the purchase amount is completed, platform 100 creates a temporary digital wallet for this transaction to transfer bitcoin to that temporary wallet. At 560, the platform's digital wallet sends a digitally signed message to the Bitcoin network, specifying the temporary digital wallet address and the amount of bitcoin to be transferred in the amount of the purchase by the user. At 570, the Bitcoin network validates, or confirms, the transaction and the bitcoin is transferred to the temporary digital wallet created by platform 100. At 580, platform 100 initiates the funds transfer according to the user's transaction validation measure to transfer funds to the platform's currency account in the amount of the purchase. At 590, platform 100 transfers the bitcoin from the temporary digital wallet to the user's personal digital wallet and then deletes the temporary digital wallet.

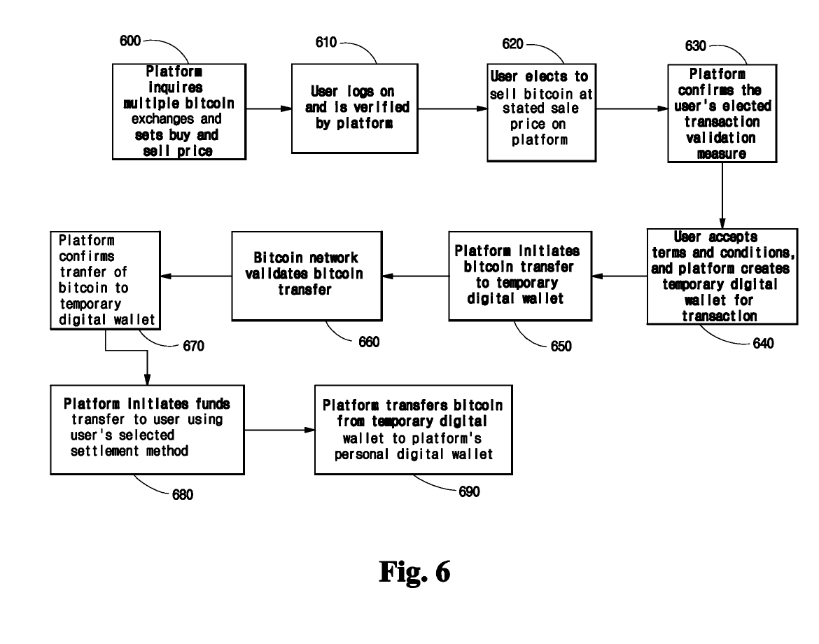

FIG. 6 is a flow scheme of a sell transaction of bitcoin to platform 100 according to one embodiment of the invention. At 600, platform 100 makes inquires at a plurality of third party bitcoin exchanges and determines a buy price and a sell price for bitcoin. At 610, a user logs on to platform 100 and platform 100 runs a security check based on the user's IP address. The user may be required to enter his/her unique encryption key. At 620, if the user successfully logs on, the user elects to sell bitcoin at the stated purchase price of platform 100. At 630, platform 100 creates a temporary digital wallet for the transaction. At 640, the user affirmatively accepts the Terms and Conditions of platform 100, which acceptance is recorded in connection with that sell transaction. At 650, the user has his/her personal digital wallet send a digitally signed message to the Bitcoin network, specifying the temporary digital wallet address and the amount of bitcoin to be transferred in the amount of the sale by the user. At 660, the Bitcoin network validates, or confirms, the transaction and the bitcoin is transferred to the temporary digital wallet. At 670, the transfer of bitcoin from the user to the temporary digital wallet has been confirmed, and then at 680 platform 100 settles the user transaction by transferring funds to the user in a funds settlement manner selected by the user. At 690, platform 100 transfers bitcoin from the temporary digital wallet into the platform digital wallet and deletes the temporary digital wallet.

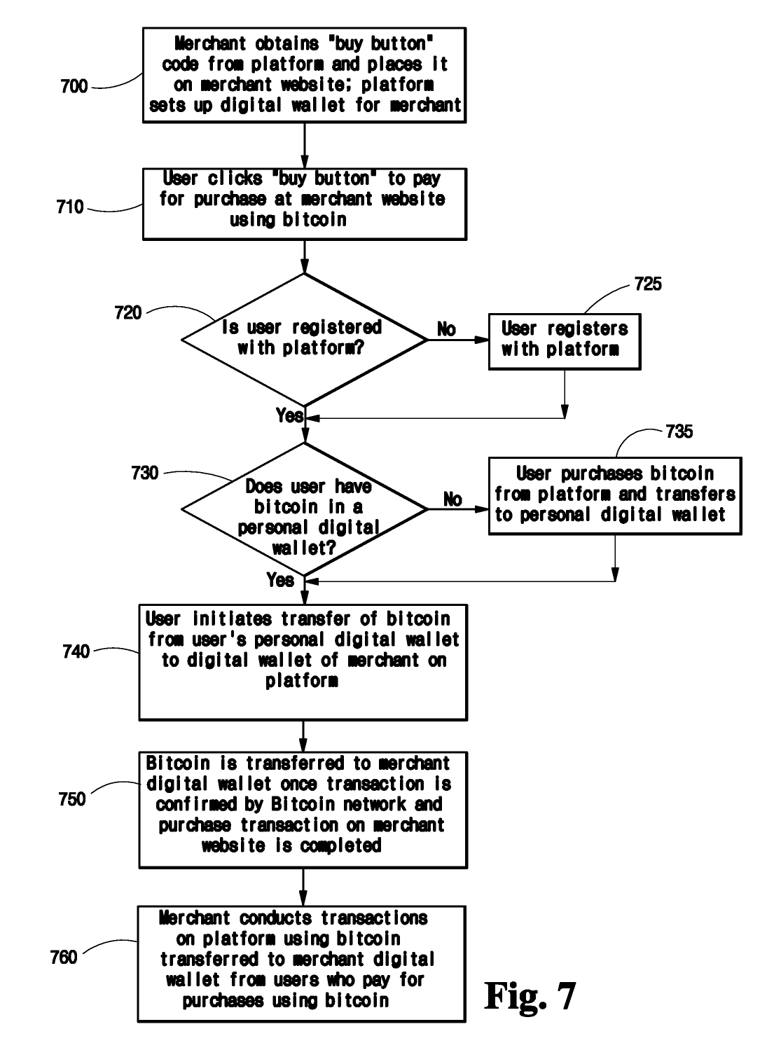

FIG. 7 is a flow scheme of one embodiment of the invention whereby a merchant is provided with code to place a “buy button” on the merchant's website so that customers can pay for purchases with bitcoin. At 700, the merchant obtains code for a “buy button” and places it on its website and platform 100 sets up a digital wallet for the merchant. At 710, when users of the merchant website want to pay for a purchase from the merchant, the user has the option to click on the merchant “buy button” and at 720 is redirected to platform 100. If at 720 the user does not already has an account with the platform, he/she can register with the platform at 725. Once user is a registered user of platform 100, at 730 the user determines if he/she has sufficient bitcoin in his/her personal wallet to cover the purchase price. If the user does not have sufficient bitcoin, at 735 he/she conducts a purchase transaction on platform 100 and transfers the bitcoin to his/her personal digital wallet. Once the user has sufficient bitcoin in his/her personal digital wallet, at 740 the user initiates a transfer of bitcoin to the merchant's digital wallet on platform 100. At 750, bitcoin is transferred to the merchant digital wallet on platform 100 and the transaction on the merchant website is completed. At 760, merchant can conduct transactions on platform 100 using bitcoin transferred from user and other purchasers who pay for purchases using bitcoin, including sale of the bitcoin in its digital wallet; transfer the bitcoin in its digital wallet on the platform to a personal digital wallet held outside of the platform; or convert some or all of the bitcoin received from the user into currency whereby the platform settles with the merchant.

The term “server” or “platform” is used generically to describe any microprocessor based device, apparatus or process capable of performing the functions described herein. It should be understood that the various functions and sequence of steps described above and attributed to the platform 100 have been provided only for the purposes of clarity and that some of these functions and steps can be performed by multiple elements and multiple systems. The steps for performing a transaction may also be performed in a different sequence.

While the above description refers to bitcoin, the invention can be used for any digital currency or any commodity or other item that is traded, or bought and sold, on the Internet. Further, transactions can be conducted in any currency.

The foregoing embodiments have been presented for the purpose of illustration and description only and are not to be construed as limiting the scope of the invention in any way.

What is claimed is:

1. A computer-implemented method for fully automated user registration with a system for the sale or purchase of digital currency comprising:
receiving a request from a potential user to register with a system;
acquiring first information from the potential user;
acquiring second information about the potential user based on contact of the potential user with the system;
acquiring actionable intelligence based on the first information acquired from the potential user and the second information about the potential user;
determining a risk score based on the first information, the second information and the actionable intelligence;
thereafter allowing the potential user access to the system if the potential user is assigned an acceptable risk score according to predetermined risk score standards set by the system, and denying access to the system if the potential user is assigned an unacceptable risk score according to the predetermined risk score standards;
thereafter acquiring third information from the potential user and verifying whether the potential user meets further predetermined qualifications;
thereafter running a check that meets OFAC, KYC and CIP standards based on the first information, the second information, the actionable intelligence and the third information; and
thereafter permitting the potential user to register with the system as a user if the potential user satisfies the OFAC, KYC and CIP standards.

2. The method of claim 1, wherein the first information comprises an email address.

3. The method of claim 1, wherein the second information comprises information based on the potential user's IP address.

4. The method of claim 1, wherein the third information comprises name, address and last four numbers of the potential user's identification information.

5. The method of claim 4, wherein the identification information comprises all or part of a Social Security number or a governmental issued identification number.

6. The method of claim 4, wherein the system comprises a digital currency exchange or a digital currency platform,
wherein in the digital currency exchange, buyers and sellers transact with each other, and the operator of the exchange is not a party to a transaction;
wherein in the digital currency platform, buyers and sellers transact with the operator of the platform to buy and sell digital currency.

7. The method of claim 6, wherein the user is assigned a unique encryption key that must be entered to gain access to the system.

8. A computer-implemented method for the sale or purchase of digital currency comprising:
a fully automated user registration process that is compliant with anti-money laundering and financial regulations and laws; and
one or more transaction validation measures for transferring money between the system and registered users,
wherein the combination of the fully automated user registration process and the transaction validation measures qualify online credit card transactions and online debit card transactions as “card present” and “PIN debit on the web” transactions for purposes of payment of merchant processing fees,
wherein the fully automated user registration process comprises:
receiving a request from a potential user to register with a system;
acquiring first information from the potential user;
acquiring second information about the potential user based on contact of the potential user with the system;
acquiring actionable intelligence based on the first information acquired from the potential user and the second information about the potential user;
determining a risk score based on the first information, the second information and the actionable intelligence;
thereafter allowing the potential user access to the system if the potential user is assigned an acceptable risk score according to predetermined risk score standards set by the system, and denying access to the system if the potential user is assigned an unacceptable risk score according to the predetermined risk score standards;
thereafter acquiring third information from the potential user and verifying whether the potential user meets further predetermined qualifications;
thereafter running a check that meets OFAC, KYC and CIP standards based on the first information, the second information, the actionable intelligence and the third information; and
thereafter permitting the potential user to register with the system as a user if the potential user satisfies the OFAC, KYC and CIP standards,
wherein the transaction validation measure comprises one or more of the purchase of a dedicated secure card reader device that is associated with the user; downloading of an application on the user's cell phone through which transactions can be performed on the system; purchase of a device that attaches to any device via audio jack or USB port connectivity that processes credit card transactions on-location; setup of an account with a third party online person-to-person payment facilitator through which funds can be transferred between the user and the system; use of third party services through which users can charge funds to a credit or debit card to fund transactions on the system; use of third party services through which users can charge funds to an e-wallet to fund transactions on the system; and through the transfer of a digital image of a check along with a code issued by the platform for clearing of the check through the platform's bank.

9. The method of claim 8 further comprising an interface between the system and a third party online person-to-person payment facilitator that allows for instant settlement of funds between the system and the user.

10. A computerized method for the purchase and sale of digital currency, comprising:
receiving log-in information from a registered user of a system that offers to sell or purchase digital currency;
permitting the user to access the system if the user satisfies predetermined on-online security standards;
receiving an encryption key from the user and determining if the encryption key was issued by the system to the user;
thereafter permitting the user to elect to purchase digital currency from the system or sell digital currency to the system if the encryption key was issued to the user by the system;
receiving affirmation of predetermined terms and conditions of the system from the user;
thereafter receiving a request from the user to purchase or sell digital currency;
wherein if the user elects to purchase digital currency, the method further comprises:
confirming that the user has elected at least one valid transaction validation measure for transfer of funds to the system in the amount of the purchase of the digital currency;
creating a temporary digital wallet for the purchase transaction;
sending a digitally signed message to a network that confirms the validity of the digital currency to be transferred to the user;
transferring the digital currency upon receipt of confirmation of validity of the digital currency into the temporary digital wallet;
confirming transfer of funds from the user to an account of the system;
transferring the digital currency from the temporary digital wallet to a personal digital wallet of the user; and
deleting the temporary digital wallet;
wherein if the user elects to sell digital currency, the method further comprises:
receiving a transfer of digital currency from the personal digital wallet of the user; and
transferring funds to an account of the user in settlement of the digital currency sale transaction.

11. The method of claim 10, wherein the-line security standards relate to the user's IP address.

12. The method of claim 11, wherein the system determines the purchase and sale price of the digital currency to the user by acquiring information from a plurality of third party digital currency exchanges on the purchase and sale price of the digital currency; and determining its own purchase and sale price by increasing the average sale price of one or more of the third party digital currency exchanges by a profit margin or decreasing the average purchase price of one or more of the third party digital currency exchanges by a profit margin.

13. The method of claim 10, wherein the digital currency comprises bitcoin.

14. The method of claim 10, further comprising a fully automated user registration process that is compliant with anti-money laundering and financial regulations and laws; and one or more transaction validation measures for transferring money between the system and registered users, wherein the combination of the fully automated user registration process and the transaction validation measures qualify online credit card transactions and online debit card transactions as “card present” and “PIN debit on the web” transactions for purposes of payment of merchant processing fees,
wherein the fully automated user registration process comprises:
receiving a request from a potential user to register with a system;
acquiring first information from the potential user;
acquiring second information about the potential user based on contact of the potential user with the system;
acquiring actionable intelligence based on the first information acquired from the potential user and the second information about the potential user;
determining a risk score based on the first information, the second information and the actionable intelligence;
thereafter allowing the potential user access to the system if the potential user is assigned an acceptable risk score according to predetermined risk score standards set by the system, and denying access to the system if the potential user is assigned an unacceptable risk score according to the predetermined risk score standards;
thereafter acquiring third information from the potential user and verifying whether the potential user meets further predetermined qualifications;
thereafter running a check that meets OFAC, KYC and CIP standards based on the first information, the second information, the actionable intelligence and the third information; and
thereafter permitting the potential user to register with the system as a user if the potential user satisfies the OFAC, KYC and CIP standards,
wherein the transaction validation measure comprises one or more of the purchase of a dedicated secure card reader device that is associated with the user; downloading of an application on the user's cell phone through which transactions can be performed on the system; purchase of a device that attaches to any device via audio jack or USB port connectivity that processes credit card transactions on-location; setup of an account with a third party online person-to-person payment facilitator through which funds can be transferred between the user and the system; use of third party services through which users can charge funds to a credit or debit card to fund transactions on the system; the use of third party services through which users can charge funds to an e-wallet to fund transactions on the system; and through the transfer of a digital image of a check along with a code issued by the platform for clearing of the check through the platform's bank.

15. The method of claim 14, wherein funds are transferred to the account of the user in settlement of the digital currency sale transaction by one or more of an ACH transaction with a user's bank account; issuance of a preloaded debit card by the system to the user in the amount of the settlement; utilizing a third party online person-to-person payment facilitator and instantly disbursing funds to the user's account with the payment facilitator by way of a wire transfer, an ACH transaction or a Check 21 substitute check or a wire.

16. The method of claim 15, wherein the user withdraw funds from the payment facilitator account by printing out a virtual check, wire, or issuance of a substitute check.

17. The method of claim 15, wherein the system comprises a privately labeled gateway to the third party online person-to-person payment facilitator account wherein any transactions utilizing the third party online person-to-person payment facilitator are conducted from the website of the system.

18. The method of claim 10, wherein all purchase and sale transactions are conducted on a single website.

19. The method of claim 10, wherein all purchase transactions are conducted on a first website and all sale transactions are conducted on a second website.

20. The method of claim 10, further comprising remote capability to operate a camera on the user's device.
